(19) United States
(12) Patent Application Publication
(10) Pub. No.: US 2026/0286171 A1
(43) Pub. Date: Sep. 24, 2026

(54) METHOD

(71) Applicant: Sumitomo Chemical Co., Ltd, Tokyo (JP)

(72) Inventors: Helen Benjamin, Godmanchester (GB); Senthil Kabali, Godmanchester (GB); Martin Humphries, Godmanchester (GB)

(73) Assignee: Sumitomo Chemical Co., Ltd, Tokyo (JP)

(21) Appl. No.: 19/476,314

(22) PCT Filed: Apr. 16, 2024
(86) PCT No.: PCT/EP2024/060321

§ 371 Date: Oct. 17, 2025

(30) Foreign Application Priority Data
Apr. 17, 2023 (GB) 2305628.6

(51) Int. Cl. C09D 165/02

(52) U.S. Cl. CPC C09D 165/02

(57) ABSTRACT

A method of forming a self-assembled film on a surface of a substrate (101). A solution comprising a block copolymer and a solvent is deposited onto the surface. The block copolymer is a rod-coil copolymer comprising a rod block A and a coil block B. The surface may carry one or more features (103) for directing self-assembly of the rod-coil polymer.

Kim et al, “Epitaxial self-assembly of block copolymers on lithographically defined nanopatterned substrates” Nature volume 424, pages 411-414 (2003) discloses self-assembly of the diblock copolymer PS-b-PMMA.

Luo and Epps, “Directed Block Copolymer Thin Film Self-Assembly: Emerging Trends in Nanopattern Fabrication” Macromolecules 2013, 46, 7567-7579 discloses directed self-assembly of block copolymer thin films.

Tseng and Darling “Block Copolymer Nanostructures for Technology”, Polymers, 2010, Vol. 2 Issue 4, 470-489 discloses block copolymer nanostructures for microelectronics and photovoltaics.

### SUMMARY

The present disclosure provides a method of forming a self-assembled film on a surface comprising deposition of a solution comprising a block copolymer and a solvent on the surface and evaporating the solvent, wherein the block copolymer is a rod-coil copolymer comprising a rod block A and a coil block B.

Optionally, the rod block A has a conjugated backbone.

Optionally, the rod block A comprises units selected from vinylene, acetylene, imine, Ar¹ and combinations thereof, each of which may be unsubstituted or substituted with one or more substituents, wherein Ar¹ is an arylene or heteroarylene group.

Optionally, the rod block A has formula (I):

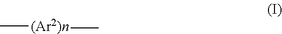

wherein Ar¹ is a monocyclic or fused aromatic or heteroaromatic group and n is greater than 1.

Optionally, Ar¹ is unsubstituted or substituted phenylene.

Optionally, the coil block has a backbone containing no double bonds or triple bonds conjugated to one another.

Optionally, the coil block backbone contains no double bonds or triple bonds.

Optionally, the coil block B is selected from formulae (II)-(VII):

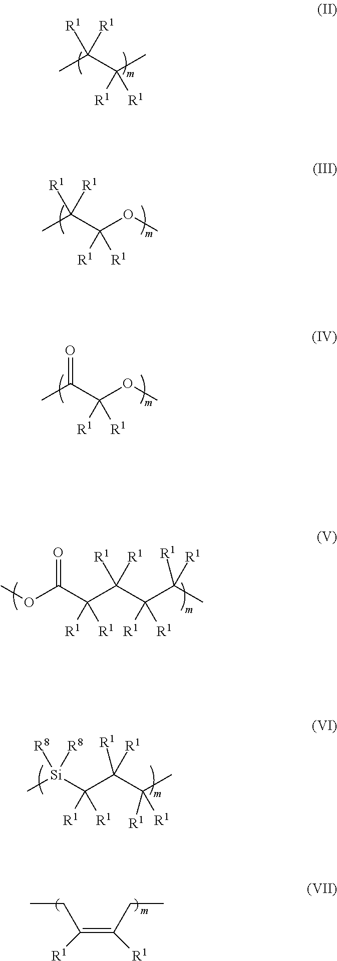

wherein R¹ in each occurrence is independently H or a substituent and m is greater than 1.

Optionally, the block copolymer comprises a linking unit linking rod block A to coil block B.

Optionally, the linking unit is an imine unit of formula —N—CR⁹— wherein R⁹ is H or a substituent.

Optionally, the linking unit is an optionally substituted monocyclic or polycyclic group.

Optionally, the block copolymer is selected from: an A-B block copolymer; an A-B-A block copolymer; and a B-A-B block copolymer.

Optionally, the block copolymer comprises a fused aromatic or heteroaromatic end group comprising at least 4 fused aromatic or heteroaromatic rings.

Optionally, the surface comprises at least one feature for directing self-assembly of the block copolymer.

Optionally, the at least one feature for directing self-assembly defines one or more areas of the substrate having a different surface energy from the remaining areas of the substrate.

Optionally, the deposited block copolymer is heated to above a glass transition temperature of the block copolymer.

The present disclosure provides a method of patterning a substrate comprising providing a directed self-assembled rod-coil block copolymer comprising a rod block A and a coil block B over a surface of the substrate; selectively removing one of the rod block A and the coil block B, preferably selectively removing the coil block B; and patterning the substrate. The rod-coil block copolymer may be as described anywhere herein.

Optionally, the substrate is a silicon substrate.

### DESCRIPTION OF DRAWINGS

The disclosed technology and accompanying figures describe some implementations of the disclosed technology.

FIG. 1 is a schematic illustration of a substrate carrying a surface feature for directing self-assembly;

FIG. 2 is a schematic illustration of a directed self-assembled layer of a rod-coil block copolymer formed on the substrate of FIG. 1;

FIG. 3 is an atomic force microscope image of a block copolymer film annealed for 2 hours; and

FIG. 4 is an atomic force microscope image of a block copolymer film annealed for 5 hours.

The drawings are not drawn to scale and have various viewpoints and perspectives. The drawings are some implementations and examples. Additionally, some components and/or operations may be separated into different blocks or combined into a single block for the purposes of discussion of some of the embodiments of the disclosed technology. Moreover, while the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers may be present.

References to a layer “on” another layer when used in this application means that the layers are in direct contact. References to a specific atom include any isotope of that atom unless specifically stated otherwise.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

The present disclosure provides a rod-coil block copolymer containing at least one rod block and at least one coil block. For simplicity, rod-coil block copolymers having a single rod block and a single coil block is described herein however, unless specifically stated otherwise, it will be understood that such a block copolymer may have more than one rod block and/or more than one coil block.

The rod block is relatively restricted in the conformations it can adopt as compared to the coil block. The present inventors have found that such rod-coil block copolymers can be used to form a self-assembled structure on a surface by directed self-assembly (DSA).

In DSA, a solution of the block copolymer is deposited onto a surface and the block copolymer self-assembles. It will be understood by the skilled persion that the self-assembled domain shapes and relative dimensions will be affected by the relative volume fraction of each block (f), the Flory-Huggins interaction parameter (x), and the degree of polymerization (N). The pattern formed by the self-assembly may be directed by one or more surface features on the substrate.

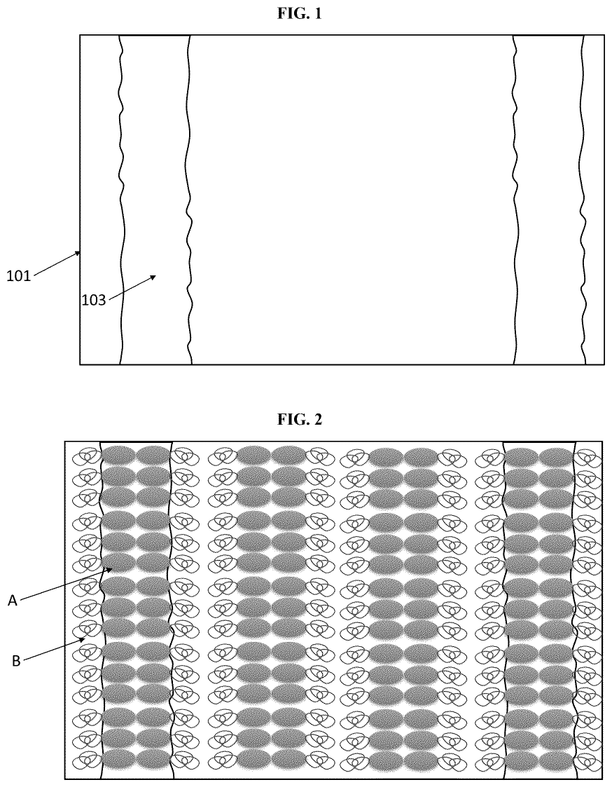

With reference to FIG. 1, surface features 103 are formed on a surface of a substrate 101, e.g., a silicon substrate. The surface features are relatively far apart due to the resolution limitation of the process by which the surface features are formed. The surface feature directing assembly of the block copolymer may be a physical feature (graphoepitaxy) such as a ridge on the substrate. The surface feature directing assembly of the block copolymer may be feature formed by chemical treatment of the substrate surface (chemoepitaxy), e.g., to change the hydrophilicity of the substrate in the surface feature area. Formation of surface features may be as described in C. Pinto Gomez, “Directed Self-Assembly of Block Copolymers for the Fabrication of Functional Devices”, Polymers 2020, 12(10), 2432, the contents of which are incorporated herein by reference.

In the embodiment of FIG. 1, the rod block A has a greater affinity for the surface feature than the coil block B. Consequently, during drying of the solution the rod self-assembles over the surface feature as shown in FIG. 2. This in turn affects arrangement of block copolymer chains which are not over the substrate feature, with rod blocks A and coil blocks B of polymer chains in solution self-organising with, respectively, rod blocks A and coil blocks B on the surface causing replication of the assembly of the block-chain copolymer structure across the area of the deposited solution, as shown in FIG. 2.

The resultant self-assembled structure comprises rod and coil domains of a smaller dimension—for example, a smaller width—than the distance between the surface features used to direct self-assembly of the block copolymer. Preferably, the surface feature and/or distance between surface features has a dimension at least 2 times or at least 5 times greater than that of the self-assembled structure. Optionally, the self-assembled structure has a dimension (e.g., width) of no more than 20 nm.

Preferably, the substrate does not comprise a brush layer for prevention of vertical phase separation.

Preferably, a top coat for prevention of vertical phase separation is not applied to the surface of the self-organised layer.

The high degree of ordering that is possible in directed self-assembly of a rod-coil block copolymer may allow for formation of domains with low edge roughness (e.g., low line edge roughness between domains of FIG. 1) and/or low variation in size of domains, even if the surface feature or features used to direct self-assembly have relatively high edge roughness and/or size variation, as shown in FIG. 1.

The self-assembled structure may be treated to selectively remove either the coil domains or the rod domains using methods known to the skilled person, for example by wet etching or plasma etching, e.g. as described in H Puliyalil et al, “Selective Plasma Etching of Polymeric Substrates for Advanced Applications”, Nanomaterials (Basel). 2016 June; 6 (6): 108; ACS Nano, 2020, 14, 4, 4289-4297; Nano Lett., 2014, 14, 10, 5698-5705; and Hiroyuki Miyazoe et al 2017 J. Phys. D: Appl. Phys. 50 204001, the contents of which are incorporated herein by reference, and the residual domains may be used to pattern the underlying substrate. For example, the residual domains may be used as either a positive photoresist or negative photoresist to pattern the underlying substrate. Preferably, the coil domains are removed.

In the embodiment of FIGS. 1 and 2, the rod block A has a greater affinity for the surface feature than the coil block B. In other embodiments, the coil block B has a greater affinity for the surface feature than the rod block A.

In the embodiment of FIG. 1, a two surface features for directing self-assembly are shown. In other embodiments, the surface may comprise no surface features; one surface features; or more than two surface features.

In the embodiment of FIG. 1, stripe surface features for directing self-assembly is shown however it will be understood that the surface feature or features may have any shape according to the desired pattern of the self-assembled block copolymer. For example, the surface feature may be in the form of one or more islands on the surface of the substrate.

Preferably, polymers as described herein have a polystyrene-equivalent weight-average molecular weight (Mw) of the polymers described herein is optionally in the range of 5,000-1,000,000, more preferably 9,000-500,000.

Preferably, polymers as described herein have a glass transition temperature as determined by differential scanning calorimetry of greater than 80° C., preferably less than 200° C.

The present inventors have found that rod-block copolymers as described herein can undergo phase separation upon deposition onto a surface to form a lamellar phase-separated structure having phase-separated features of less than 100 nm, optionally less than 50 nm or less than 20 nm and optionally of at least 5 nm as measured by atomic force microscopy.

### Rod Block

The block copolymer comprises at least one rod block A.

In some embodiments, the block copolymer comprises a single rod block. Exemplary block copolymers according to these embodiments are A-B and B-A-B block copolymers.

In some embodiments, the block copolymer comprises a plurality of rod blocks. An exemplary block copolymer according to these embodiments is A-B-A.

The rod block comprises a chain of groups selected from vinylene, acetylene, imine, proline, Ar¹ and combinations thereof wherein Ar¹ is an arylene or heteroarylene group. Combinations include, for example, arylenevinylene and aryleneacetylene groups. The rod block is preferably at least partially conjugated along its backbone, and may be conjugated along the entire length of its backbone. However, rod blocks may be formed from non-conjugating units, for example proline.

It will be understood that the rod block is relatively restricted in the conformations it can adopt as compared to the coil block, with the freedom of movement along the backbone of the rod being mainly restricted to rotation of Ar¹ groups relative to one another. As such, the rod block is relatively rigid as compared to the coil block.

The rod block A may have formula —(Ar¹)ₙ— wherein Ar¹ is an aromatic or heteroaromatic group which is unsubstituted or substituted with one or more substituents and n is more than 1.

Preferably, n is at least 3, optionally 3-20. In a preferred embodiment, the rod block is monodisperse, i.e., n is the same for all molecules of the block copolymer. In other embodiments, the rod block is polydisperse in which case n is a number average. Preferably, if the rod block is polydisperse the polydispersity of the rod block is less than 2, more preferably less than 1.5, yet more preferably less than or equal to 1.1.

Preferred aromatic Ar¹ groups, which may be in a rod block of formula —(Ar¹)ₙ— or which may be used in combination with one or more of vinylene, acetylene and imine units, are selected from formulae (I-A)-(I-F), more preferably (I-A) or (I-B):

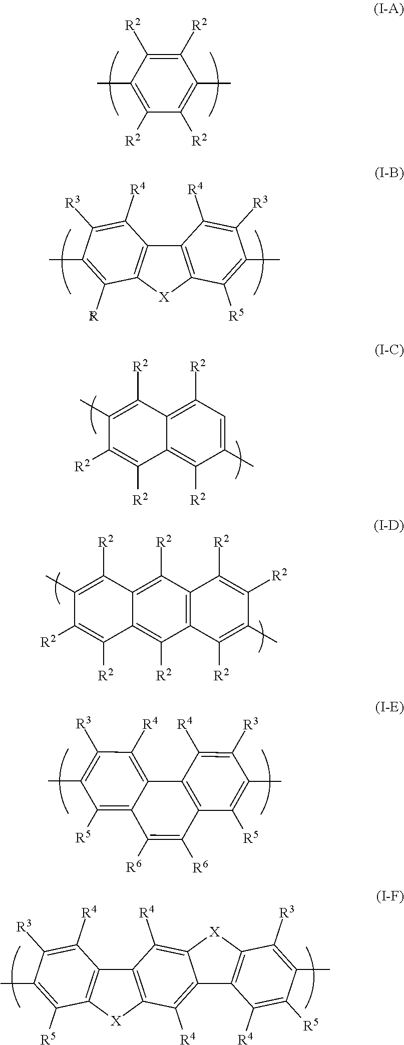

wherein R², R³, R⁴, R⁵ and R⁶ in each occurrence is H or a substituent; X is O, S, NR⁷, C(R⁸)₂ or Si(R⁸)₂ wherein R⁷ is H or a substituent and R⁸ in each occurrence is independently a substituent.

R², R³, R⁴, R⁵ and R⁶ are each independently selected from H; F; C₁₋₂₀ alkyl wherein one or more non-adjacent, non-terminal C atoms may be replaced with O, S, NR⁷, Si(R⁸)₂, OSi(R⁸)₂, CO, COO or CONR⁷ and one or more H atoms may be replaced with an optionally substituted aryl or heteroaryl group or F; an optionally substituted aryl group; and an optionally substituted heteroaryl group.

By “non-terminal C atom” of an alkyl group as used herein means a C atom of an alkyl group other than the C atom of the methyl group at the chain end of an n-alkyl chain or the C atoms of each methyl group at each chain end of a branched alkyl chain.

An aryl or heteroaryl group of any one of R², R³, R⁴, R⁵ and R⁶ is preferably a C₆₋₁₂ aryl group, more preferably phenyl, which may be unsubstituted or substituted or one or more substituents. Substituents may be selected from F, Cl, NO2, CN and C₁₋₁₂ alkyl wherein one or more non-adjacent, non-terminal C atoms may be replaced with O, S, NR⁶, Si(R⁸)₂, OSi(R⁸)₂, CO, COO or CONR⁶ and one or more H atoms may be replaced with F.

For formulae (I-A), (I-B) and (I-D), preferably at least one group R², more preferably one or two groups R², are not H and remaining R² groups are H.

Preferably, each R³ is H and/or each R⁴ is H.

Each R⁵ is preferably H.

R⁷ is preferably H or a C₁₋₂₀ hydrocarbyl group. A C₁₋₂₀ hydrocarbyl group as described anywhere herein may be selected from C₁₋₂₀ alkyl and phenyl which is unsubstituted or substituted with one or more C₁₋₁₂ alkyl groups.

R⁸ in each occurrence may be the same or different and is preferably selected from C₁₋₂₀ alkyl wherein one or more non-adjacent, non-terminal C atoms may be replaced with O, S, NR⁷, CO, COO or CONR⁷ and one or more H atoms may be replaced with an optionally substituted aryl or heteroaryl group or F; an optionally substituted aryl group; and an optionally substituted heteroaryl group.

An aryl or heteroaryl group of R⁸ is preferably a C₆₋₁₂ aryl group, more preferably phenyl, which may be unsubstituted or substituted or one or more substituents. Substituents may be selected from F, Cl, NO2, CN and C₁₋₁₂ alkyl wherein one or more non-adjacent, non-terminal C atoms may be replaced with O, S, NR⁷, CO, COO or CONR⁷ and one or more H atoms may be replaced with F.

Preferred heteroaromatic groups Ar¹ are thiophene and furan, each of which may be unsubstituted or substituted with one or more substituents. Substituents of a heteroaromatic group Ar¹ are optionally selected from non-H groups R² as described above.

### Coil Block

The backbone of the coil block has greater freedom of movement than the rod block. Consequently, the coil block is relatively flexible as compared to the rod block.

The backbone of the coil block preferably contains no double bonds or triple bonds conjugated to one another and more preferably contains no double bonds or triple bonds. The coil block may contain, for example, a C—O or C═N unit wherein only the C atom of the C—O or C═N is in the coil block backbone. According to some embodiments, the coil block contains only sp3-hybridised atoms in its backbone, for example sp3 hybridised C, O, S and/or N atoms.

Preferred coil blocks B include formulae (II)-(VII):

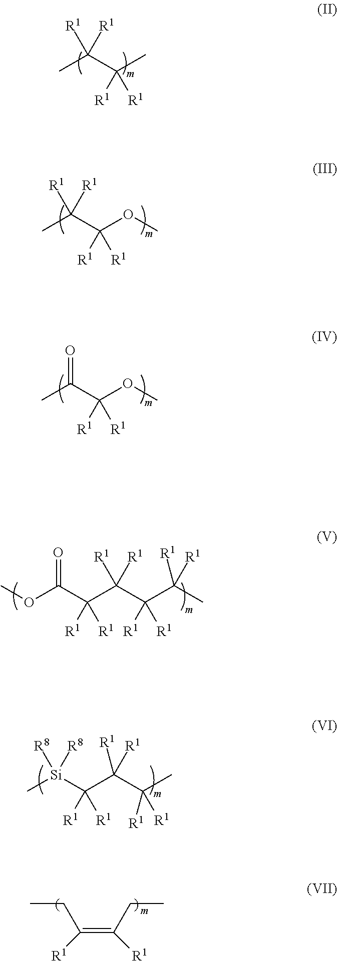

wherein R¹ in each occurrence is H or a substituent and m is greater than 2. Preferably, m is in the range of 10-5,000, optionally 20-3,000.

Each R¹ is preferably independently selected from H; F; Cl; an aromatic or heteroaromatic group Ar², preferably phenyl or pyridyl; COOR⁷; CONR⁷₂ and a C₁₋₂₀ alkyl wherein one or more non-terminal C atoms of the alkyl may be replaced with O, S, NR⁷, CO, COO or CONR⁷ wherein R⁷ is as described above and wherein one or more H atoms of the C₁₋₂₀ alkyl may be replaced with F.

Ar² may be unsubstituted or substituted with one or more substituents. Substituents of Ar², if present, may be selected from F; CN; NO2 and C₁₋₂₀ alkyl wherein one or more non-terminal C atoms of the alkyl may be replaced with O, S, NR⁶, CO, COO or CONR⁶ and one or more H atoms of the alkyl may be replaced with F.

Preferred substituents R¹ are optionally substituted benzene (i.e., in which the repeat unit of formula (II) is a styrene or substituted analogue thereof) and —COO—C₁₋₁₉ alkyl (i.e., in which the repeat unit of formula (II) is an acrylate, e.g., methacrylate). According to these embodiments, preferably only one R¹ is a substituent and all other R¹ groups are H.

### End Group

An end of a rod block or an end of a coil block which is not connected through a connecting unit to an end of the other of a rod block and a coil block may be substituted with H or a substituent.

In the case where the block copolymer has a rod block A at an end of the polymer backbone, for example an A-B or an A-B-A block copolymer, the rod block end may be substituted with an end group comprising or consisting of an optionally substituted fused aromatic or heteroaromatic ring system.

Optionally, the end group is a fused aromatic or heteroaromatic ring system comprising at least 4 fused rings, optionally at least 6 fused rings, optionally at least 8 or at least 10 fused rings. The fused ring system is preferably a fused aromatic ring system. In a preferred embodiment, the fused ring system consists of fused benzene rings.

Substituents of the fused ring system, where present, may be selected from non-H groups R² as described above.

An exemplary end group of the rod block is:

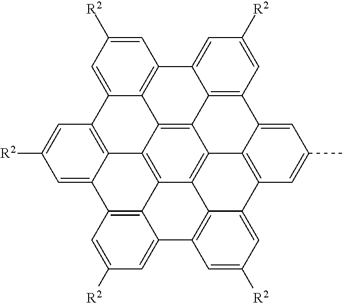

A planar fused aromatic or heteroaromatic ring system end group may facilitate pi-pi stacking of the rod block A.

### Connecting Unit

In some embodiments, the, or each, rod block is bound directly to at least one coil block.

In some embodiments, the block copolymer includes at least one connecting unit connecting a coil block to a rod block.

In some preferred embodiments, rod and coil blocks are connected through an imine connecting unit. In these embodiments, an end of the rod block A is substituted with one of an aldehyde (—C(═O) H) reactive group and an amine (—NHR⁹) reactive group and an end of the coil block B is substituted with the other of an aldehyde and an amine group, wherein R⁹ is H or a substituent, preferably H or a C₁₋₁₂ alkyl, more preferably H. In the case of an A-B-A block copolymer, both ends of the coil block B are substituted with the same reactive group. In the case of a B-A-B block copolymer, both ends of the rod block A are substituted with the same reactive group.

### Polymer Synthesis

Formation of rod-coil block copolymers as described herein may comprise providing a rod block; providing a coil block; and covalently connecting at least one rod block to at least one coil block using any connection known to the skilled person.

In the case where the rod block comprises a fused aromatic or heteroaromatic end group, the end group may be formed before or after connection of the rod and coil blocks. A rod block as described herein may be formed by any method known to the skilled person.

In some embodiments, the rod block is grown by stepwise addition of units of the rod block to form a monodisperse rod block.

In some embodiments, the rod block is formed by polymerisation. Exemplary methods known to the skilled person for forming a conjugated polymer include Suzuki polymerisation as described in WO 00/53656 or U.S. Pat. No. 5,777,070, the contents of which are incorporated herein by reference, and Yamamoto polymerisation. The polydispersity of a polymerised rod block may be controlled by any method known to the skilled person, for example as disclosed in Macromolecules 2011, 44, 9, 3388-3397 or J. Am. Chem. Soc. 2007, 129, 23, 7236-7237, the contents of which are incorporated herein by reference.

A coil block as described herein may be formed by any method known to the skilled person, for example free radical polymerisation of an optionally substituted ethylene.

In some preferred embodiments, the polymer comprises a plurality of parallel rod blocks and/or a plurality of parallel coil blocks. According to these embodiments, the rod and coil blocks are connected through a monocyclic or fused ring connecting group, optionally a connecting group of formula (VIII):

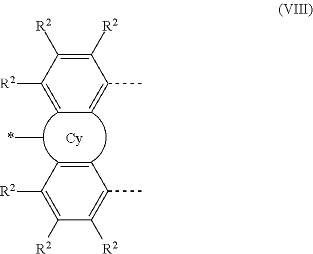

wherein Cy is a ring, preferably a 6-membered ring; R² is as defined above; each --- represent a bond to a rod block; and * represents a bond to a coil block.

Preferably, Cy is benzene or:

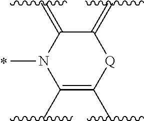

wherein Q is O or S.

A block copolymer comprising a connecting group of formula (VIII) may have the following formula in which Block A¹ is a first rod block; Block A² is a second rod block; and Block B is a coil block:

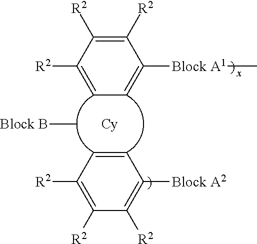

Exemplary rod-coil block copolymers include the following wherein R² and R⁸ are as described above and are each preferably a C₄₋₁₂ alkyl group.

### A-B Block Copolymers

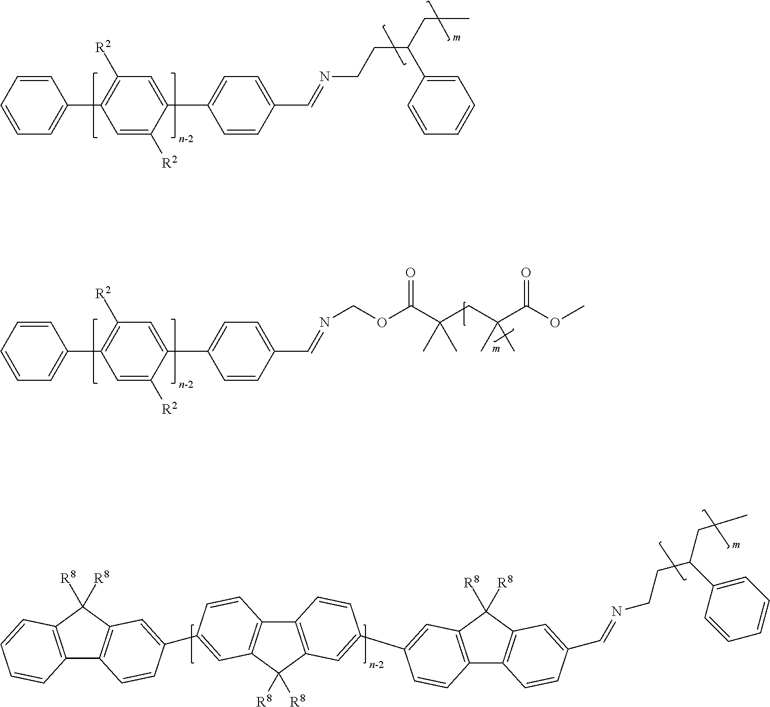

### A-B-A Block Copolymer

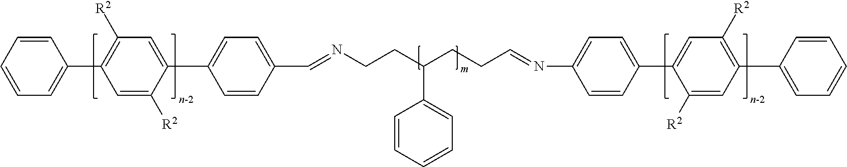

### B-A-B Block Copolymer

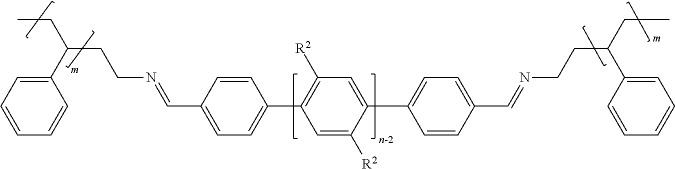

### A-B Block Copolymer with Fused Rod Block End Group

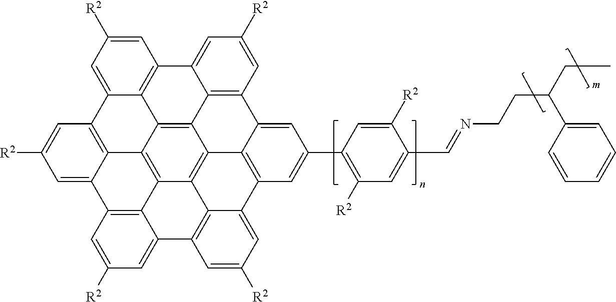

### Block Copolymer with Stacked Rod Blocks

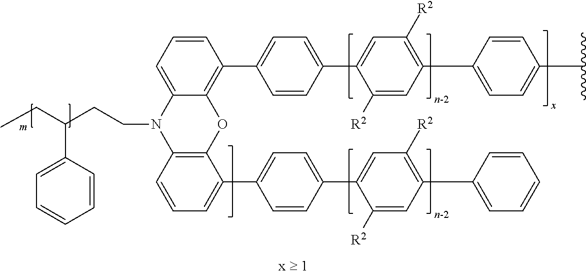

### Film Formation

The self-assembled polymer film may be formed by depositing a solution comprising one or more solvents and the polymer onto a surface optionally having one or more directing surface features and evaporating the one or more solvents.

The one or more solvents may be selected according to the solubility of the block copolymer which may depend on the solubilities of the individual blocks.

Optionally, solvents are selected from one or more benzene substituted with one or more substituents selected from Cl, C₁₋₆ alkyl, and C₁₋₆ alkoxy wherein two alkyl groups may be linked to form a ring, for example toluene, xylenes, trimethylbenzenes, anisole, indane, tetralin, dichlorobenzene; cyclic or acyclic ethers for example tetrahydrofuran, dioxan or di(C₁₋₆ alkyl) ethers; chlorinated C₁₋₆ alkanes for example chloroform or dichloromethane; and mixtures thereof.

Following deposition of the solution, heat is optionally applied to drive off the solvent or solvents. Upon film formation, the polymer is preferably heated to above its glass transition temperature. Optionally, heating is at a temperature of at least 120° C., optionally at least 180° C.

The film comprising the block copolymer preferably has a thickness of no more than 500 nm, optionally no more than 100 nm.

In some embodiments, the surface is preferably a silicon surface.

The present inventors have found that self-assembly can be achieved without any treatment of the surface that the block copolymer is deposited onto. Therefore, the deposition surface preferably does not contain regions of differing surface properties; preferably, the solution comprising the block copolymer is deposited directly onto the silicon surface.

### EXAMPLES

Rod-coil block copolymers were synthesised by linking rod block Oligomer A1 to coil blocks B1, B2 or B3.

### Synthesis of Oligomer A1

### Synthesis of Intermediate 1-2

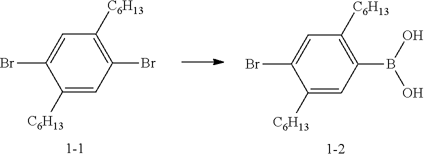

To a stirred solution of 1,4-dibromo-2,5-dihexylbenzene (100 g, 0.25 mol) in THF (1 L) was added n-BuLi (2.5 M, 108 mL, 0.27 mol) at −78° C. After stirring at −78° C. for 3 hours. triisopropyl borate (60.48 g, 73.9 mL, 0.32 mol) was added and the mixture allowed to warm to room temperature and stirred for a further 16 hours. After this time, 6M HCL (150 mL) was added and the mixture was stirred at 25° C. for an hour. The reaction mixture was concentrated under vacuum and the resulting solid was triturated with acetonitrile (500 mL) and further purified by recrystallization from a mixture of hot toluene (1 L) and acetonitrile (500 mL) to afford Intermediate 1-2 (80 g, 88% yield).

¹H-NMR (400 MHz, MeOD): δ [ppm] 0.92 (t, J=5.60 Hz, 6H), 1.33-1.36 (m, 12H), 1.57-1.58 (m, 4H), 2.56 (t, J=8.00 Hz, 2H), 2.71 (t, J=8.00 Hz, 2H), 7.15 (s, 1H), 7.37 (s, 1H). LCMS: 98.0% purity.

### Synthesis of Intermediate 1-3

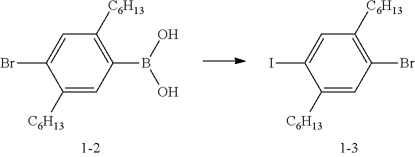

To a stirred solution of (4-bromo-2,5-dihexylphenyl) boronic acid (Intermediate 1-2, 5 g, 13.5 mmol) in acetonitrile (50 mL) was added potassium carbonate (4.68 g, 33.8 mmol). The reaction mixture was purged with N₂ gas for 15 minutes, then iodine (6.85 g, 27 mmol) was added and the reaction mixture heated at 80° C. for 16 hours. The reaction mixture was concentrated under vacuum, diluted with ethyl acetate (100 mL) and washed with water (100 mL). The organic layer was separated and passed through a fluorosil plug, concentrated and purified by column chromatography using 100% hexane as eluant (SiO₂ 230-400 mesh) to afford Intermediate 1-3 (4 g, 65% yield).

¹H-NMR (400 MHz, MeOD): δ [ppm] 0.93 (t, J=5.60 Hz, 6H), 1.34-1.35 (m, 12H), 1.54-1.55 (m, 4H), 2.65-2.65 (m, 4H), 7.41 (s, 1H), 7.70 (s, 1H). HPLC: 99.2% purity.

### Synthesis of Intermediate 1-4

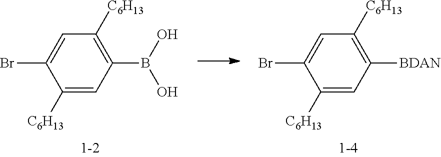

A mixture of Intermediate 1-2 (7 g, 18.9 mmol) and naphthalene-1,8-diamine (3.29 g, 20.8 mmol) in toluene (350 mL) was heated to 140° C. for 4 hours. The reaction mass was then concentrated and the crude product was purified twice by column chromatography to afford Intermediate 1-4 (4.8 g, 68% yield).

¹H-NMR (400 MHz, CDCl₃): δ [ppm] 0.86 (t, J=3.60 Hz, 3H), 0.93 (t, J=3.60 Hz, 3H), 1.27-1.37 (m, 12H), 1.61-1.61 (m, 4H), 2.68-2.70 (m, 4H), 5.79 (s, 2H), 6.37 (d, J=7.20 Hz, 2H), 7.09 (d, J=8.40 Hz, 2H), 7.14 (s, 1H), 7.17 (d, J=8.00 Hz, 1H), 7.28 (d, J=2.00 Hz, 1H), 7.42 (s, 1H). HPLC: 99.7% purity.

### Synthesis of Intermediate 1-5

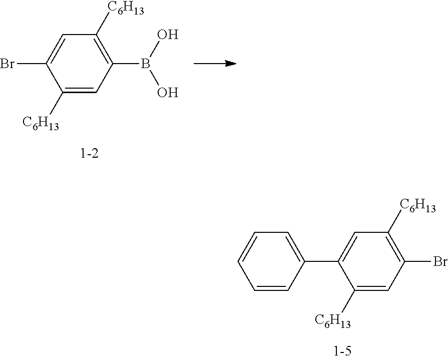

To a stirred solution of Intermediate 1-2 (15 g, 40.6 mmol) and iodobenzene (8.28 g, 40.6 mmol) in a mixture of toluene (80 mL), ethanol (60 mL) and water (20 mL) was added potassium carbonate (8.41 g, 60.9 mmol). The reaction mixture was purged with N₂ for 15 minutes, tetrakis(triphenylphosphine) palladium (0) (1.39 g, 1.21 mmol, 3 mol %) was added and the reaction heated at 100° C. for 16 hours. The reaction mixture was concentrated under vacuum and the crude residue was purified by column chromatography using 30% ethyl acetate in hexane as eluent (230-400 silica mesh) and recrystallization (toluene:acetonitrile) to afford Intermediate 1-5 as a while solid (10.5 g, 61% yield).

¹H-NMR (400 MHz, CDCl₃): δ [ppm] 0.84 (t, J=7.20 Hz, 3H), 0.91 (t, J=7.20 Hz, 3H), 1.15-1.16 (m, 6H), 1.33-1.47 (m, 8H), 1.61-1.62 (m, 2H), 2.51 (t, J=8.00 Hz, 2H), 2.72 (t, J=8.00 Hz, 2H), 7.06 (s, 1H), 7.28-7.29 (m, 2H), 7.35-7.46 (m, 4H).

### Synthesis of Intermediate 1-6

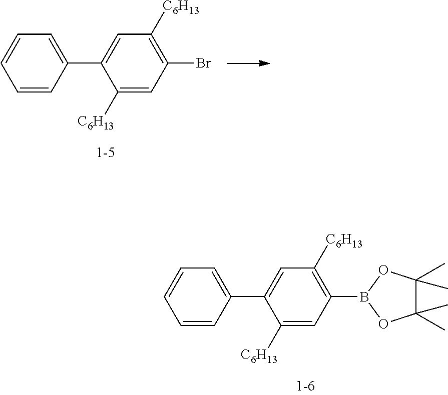

To a stirred solution of Intermediate 1-5 (10 g, 24.9 mmol) in 1,4-dioxane (100 mL) was added KOAc (6.1 g, 62.2 mmol) and B₂Pin₂ (7.56 g, 29.8 mmol). The reaction mixture was purged with N₂ for 15 minutes, PdCl₂ (dppf) (610 mg, 745 μmol, 3 mol %) was added and the reaction mixture refluxed at 100° C. for 16 hours. It was then diluted with water and extracted with ethyl acetate, the organic layer was dried over anhydrous sodium sulphate, concentrated under reduced pressure and the crude solid triturated with hexane and filtered to afford Intermediate 1-6 (10.5 g. 94% yield).

¹H-NMR (400 MHz, CDCl₃): δ [ppm] 0.83 (t, J=7.20 Hz, 3H), 0.90 (t, J=6.80 Hz, 3H), 1.17-1.18 (m, 6H), 1.30-1.58 (m, 22H), 2.56 (t, J=7.20 Hz, 2H), 2.87 (t, J=8.00 Hz, 2H), 7.04 (s, 1H), 7.31-7.39 (m, 3H), 7.41-7.41 (m, 2H), 7.69 (s, 1H).

### Synthesis of Intermediate 1-7

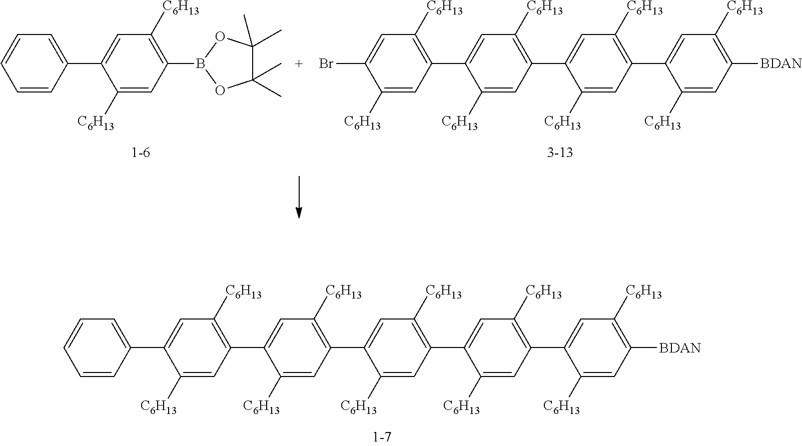

To a solution of Intermediate 1-6 (328 mg, 0.73 mmol) and Intermediate 3-13 (600 mg, 0.50 mmol, synthesis described below) in THF (10 mL) was added Na₂CO₃ (103 mg, 1.0 mmol) in water (1 mL), and the reaction mixture purged with N₂ for 5 minutes. Tetrakis(triphenylphosphine) palladium (0) (16.9 mg, 3 mol %) was added and the reaction heated at 90° C. for 5 hour until the starting material had been completely consumed. The reaction mixture was diluted with water, extracted with EtOAC and the organic layer dried over anhydrous sodium sulphate and concentrated under reduced pressure. The crude product was purified by reverse phase column chromatography using acetonitrile:THF (50%) as eluent (GRACE RP, C₁₈ column) followed by trituration with a mixture of hexane and ethyl acetate to afford Intermediate 1-7 (0.35 g, 49% yield). LCMS: 94.9% purity.

### Synthesis of Intermediate 1-8

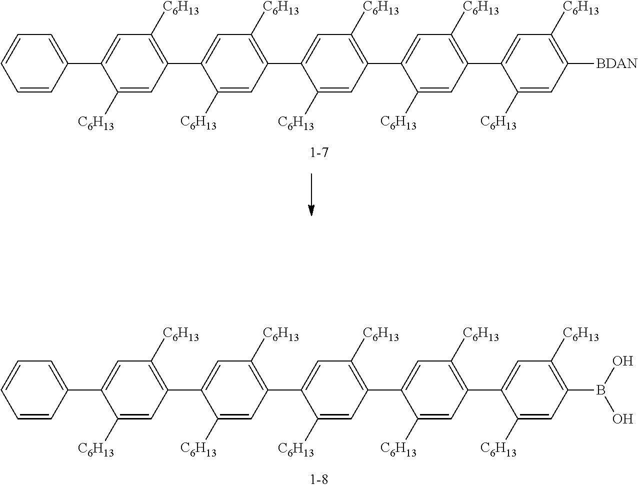

5N HCl (20 mL) was added to a solution of Intermediate 1-7 (0.85 g, 579 μmol) in THF (30 mL) and the reaction mixture was refluxed at 75° C. for 4 hours. It was then cooled to room temperature and the resulting solid was filtered and washed with acetonitrile to afford Intermediate 1-8 as a white solid (0.7 g, 85% yield). LCMS: 90.8% purity.

### Synthesis of Intermediate 2-2

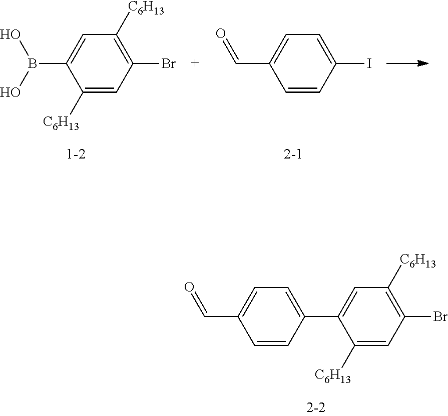

Intermediate 1-2 (15 g, 40.5 mmol), 4-iodobenzaldehyde (9.4 g, 40.5 mmol) and potassium carbonate (11.2 g, 81 mmol) in a mixture of toluene (120 mL), ethanol (90 mL) and water (30 mL) were purged with N₂ for 15 minutes. Tetrakis(triphenylphosphine) palladium (0) (1.39 g, 3 mol %) was added and the reaction heated at 95° C. for 16 hours. It was concentrated and the crude product purified by column chromatography using 3% ethyl acetate in hexane as eluent (SiO₂, 230-400 mesh) to afford Intermediate 2-2 (12.5 g, 72% yield).

¹H-NMR (400 MHz, CDCl₃): δ [ppm] 0.86 (t, J=6.80 Hz, 3H), 0.91-0.92 (m, 3H), 1.15-1.21 (m, 6H), 1.32-1.46 (m, 8H), 1.60-1.66 (m, 2H), 2.50 (t, J=8.00 Hz, 2H), 2.73 (t, J=8.00 Hz, 2H), 7.04 (s, 1H), 7.46-7.46 (m, 3H), 7.94-7.94 (m, 2H), 10.10 (s, 1H).

### Synthesis of Intermediate 2-3

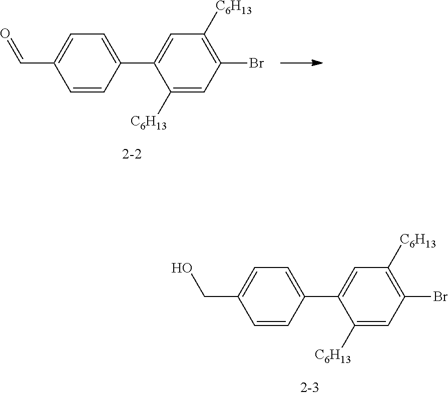

Sodium borohydride (520 mg, 139 mmol) was added in five lots to a solution of Intermediate 2-2 (6 g, 13.9 mmol) in a mixture of THF (50 ml) and methanol (10 ml) and cooled to 0° C. The reaction mixture was stirred at room temperature for 3 hours, quenched with 1.5N HCl and extracted with DCM. The organic layer was dried over anhydrous sodium sulphate, concentrated under reduced pressure and the crude product purified by column chromatography to afford Intermediate 2-3 (4 g, 66% yield).

¹H-NMR (400 MHz, CDCl₃): δ [ppm] 0.85 (t, J=7.20 Hz, 3H), 0.89-0.90 (m, 3H), 1.17-1.30 (m, 6H), 1.33-1.48 (m, 8H), 1.59-1.61 (m, 2H), 2.51 (t, J=8.00 Hz, 2H), 2.72 (t, J=8.00 Hz, 2H), 4.78 (s, 2H), 7.04 (s, 1H), 7.29 (d, J=8.00 Hz, 2H), 7.43 (d, J=8.40 Hz, 2H), 7.46 (s, 1H). LCMS purity: 95.4%.

### Synthesis of Intermediate 2-4

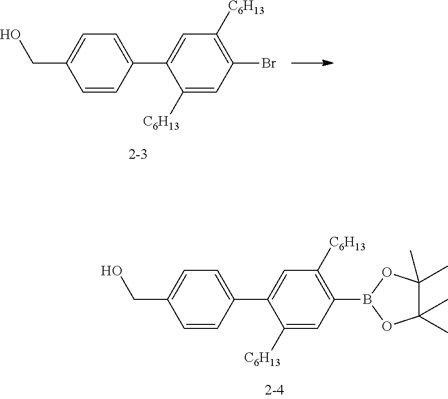

Potassium acetate (3.50 g, 35.7 mmol) and B₂Pin₂ (4.34 g, 17.2 mmol) were added to a solution of Intermediate 2-3 (6.2 g, 14.3 mmol) in 1,4-dioxane (60 ml). The reaction mixture was purged with nitrogen for 15 minutes then PdCl₂ (dppf) (350 mg, 429 μmol, 3 mol %) was added and the reaction mixture refluxed at 100° C. for 16 hours. It was then diluted with ethyl acetate, passed through a celite plug and concentrated under vacuum. The crude product was purified by column chromatography using 30% ethyl acetate in hexane as eluent (SiO₂ 230-400 mesh) to afford Intermediate 2-4 as a white solid (5 g, 74% yield).

¹H-NMR (400 MHz, CDCl₃): δ [ppm] 0.84 (t, J=7.20 Hz, 3H), 0.90 (t, J=6.80 Hz, 3H), 1.17-1.27 (m, 6H), 1.29-1.35 (m, 8H), 1.38 (s, 12H), 1.40-1.48 (m, 4H), 1.55-1.56 (m, 2H), 4.78 (s, 2H), 7.02 (s, 1H), 7.32 (d, J=8.00 Hz, 2H), 7.42 (d, J=8.00 Hz, 2H), 7.69 (s, 1H).

### Synthesis of Intermediate 2-5

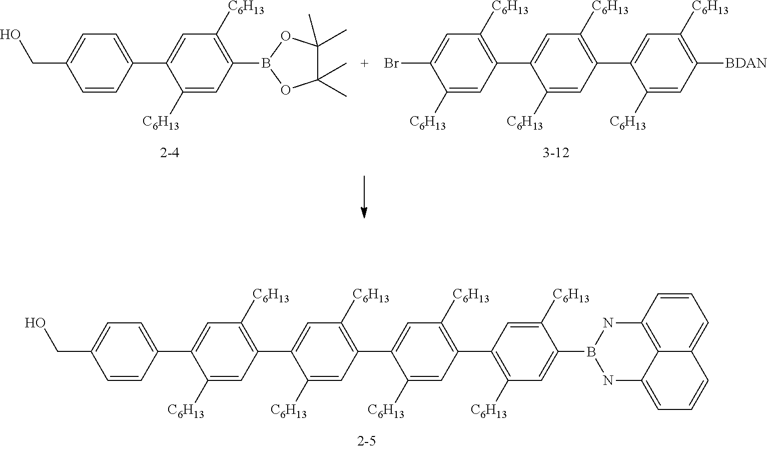

Potassium carbonate (211 mg, 1.53 mmol) in water (1.2 ml) was added to a solution of Intermediate 2-4 (439 mg, 0.92 mmol) and Intermediate 3-22 (0.6 g, 0.61 mmol) in THF (12 ml). and reaction mixture purged with N₂ for 15 minutes. tetrakis(triphenylphosphine) palladium (0) (21 mg, 3 mol %) was added and the reaction mixture heated at 90° C. for 3 hours. A further portion of potassium carbonate (0.1 equivalent) was added, N₂ purging was continued for another 5 minutes before adding an additional lot of tetrakis(triphenylphosphine) palladium (0) (21 mg, 3 mol %). After stirring for 45 hours at 90° C. the reaction was cooled, diluted with water and extracted with ethyl acetate. The organic layer was dried over anhydrous sodium sulphate, concentrated under reduced pressure and the crude product was purified by reverse phase column chromatography using 50% THF in acetonitrile as eluent (GRACE RP, C₁₈ column) followed by recrystallization in a mixture of ethyl acetate in hexane to afford Intermediate 2-5 as a white solid (0.65 g, 86% yield).

¹H-NMR (400 MHz, CDCl₃): δ [ppm] 0.83-0.88 (m, 24H), 1.22-1.22 (m, 50H), 1.46-1.52 (m, 14H), 1.65-1.70 (m, 2H), 2.33-2.47 (m, 12H), 2.60-2.65 (m, 2H), 2.76-2.80 (m, 2H), 4.81 (s, 2H), 5.94 (s, 1H), 6.41 (d, J=7.20 Hz, 2H), 7.16-7.20 (m, 11H), 7.39 (s, 1H), 7.45 (q, J=8.40 Hz, 4H). HPLC: 88.4% purity.

### Synthesis of Intermediate 2-6

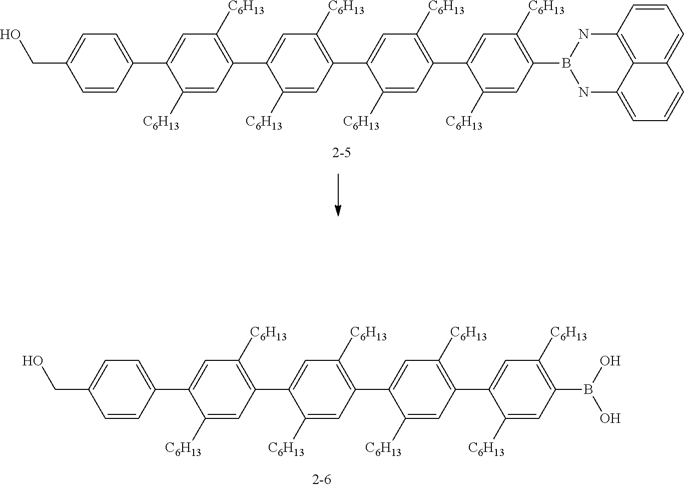

5N HCl (10 ml) was added slowly to a solution of Intermediate 2.5 (0.9 g, 0.72 mmol) in THF (20 mL). The reaction mixture was refluxed at 75° C. for 16 hours, cooled filtered and the resulting solid washed with acetonitrile to afford Intermediate 2.6 as a white solid (0.73 g, 90% yield). LCMS: 84.3% purity (note: mass observed as acetate adduction).

### Synthesis of Intermediate 3-11, 3-12, and 3-13

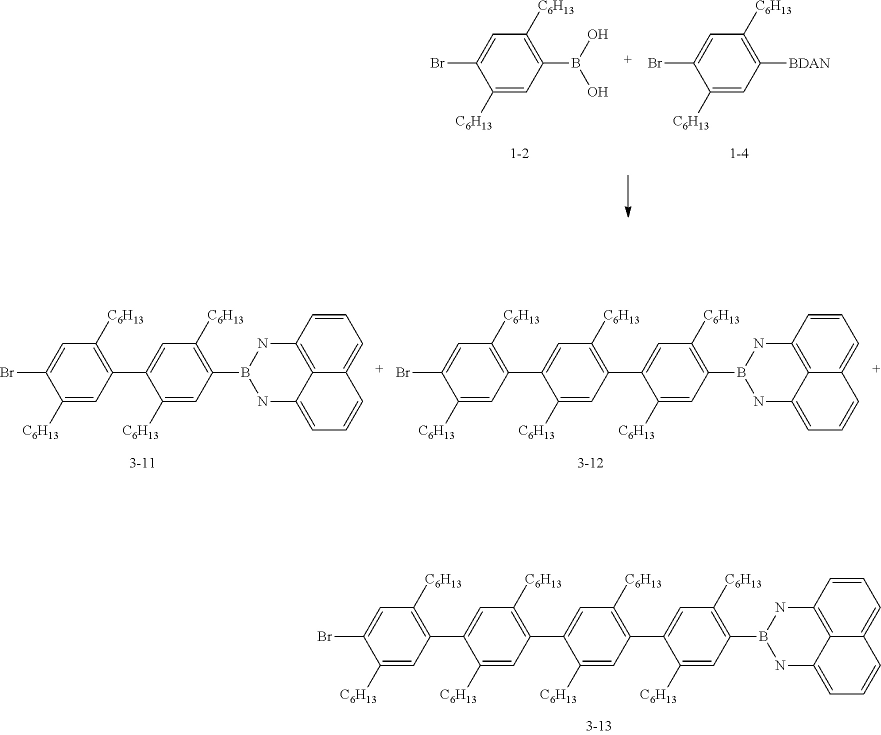

A solution of Na₂CO₃ (5.74 g, 54.2 mmol) in water (15 mL) was added to a N₂ purged solution of Intermediate 1-2 (10 g, 27.1 mmol) and Intermediate 1-4 (9.11 g, 18.5 mmol) in a mixture of toluene (180 mL) and ethanol (60 mL). After purging again with N₂ for 15 minutes, tetrakis(triphenylphosphine) palladium (0) (3.1 g, 10 mol %) was added and the reaction mixture refluxed stirred at 90° C. for 16 hours. After this time the reaction mixture was diluted with water, extracted with ethyl acetate and the organic layer dried over anhydrous sodium sulphate and concentrated under reduced pressure. The crude product was purified by reverse phase column chromatography using acetonitrile:THF as eluent (GRACE RP, C₁₈ column) to afford Intermediate 3-11 (F1: 2.5 g), Intermediate 3-12 (F2: 1.6 g) and Intermediate 3-12 (F3: 1.1 g).

### Synthesis of Intermediate 4-1

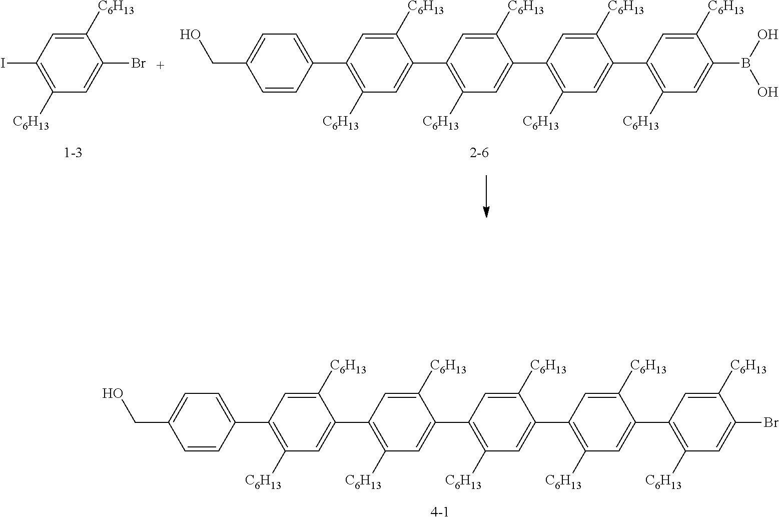

Potassium carbonate (730 mg, 0.53 mmol) was added to a solution of Intermediate 1-3 (143 mg, 0.32 mmol) and Intermediate 2-6 (0.3 g, 0.27 mmol) in a mixture of toluene (5 mL), ethanol (2 mL) and water (2 mL). The reaction mixture was purged with N₂ for 10 minutes, tetrakis(triphenylphosphine) palladium (0) (9.18 mg, 7.95 μmol, 3 mol %) was added and the mixture refluxed at 90° C. for 4 days. The reaction mixture was cooled and filtered through a fluorosil plug, diluted with water and extracted with ethyl acetate. The organic layer was dried over anhydrous sodium sulphate and concentrated under reduced pressure and the crude product was purified by reverse phase column chromatography using 58% THF:acetonitrile as eluent (GRACE RP, C₁₈ column) to afford Intermediate 4-1 as an off-white solid (310 mg, 83% yield). LCMS: 95.2% purity (note: mass observed as acetate adduction).

### Synthesis of Intermediate 4-2

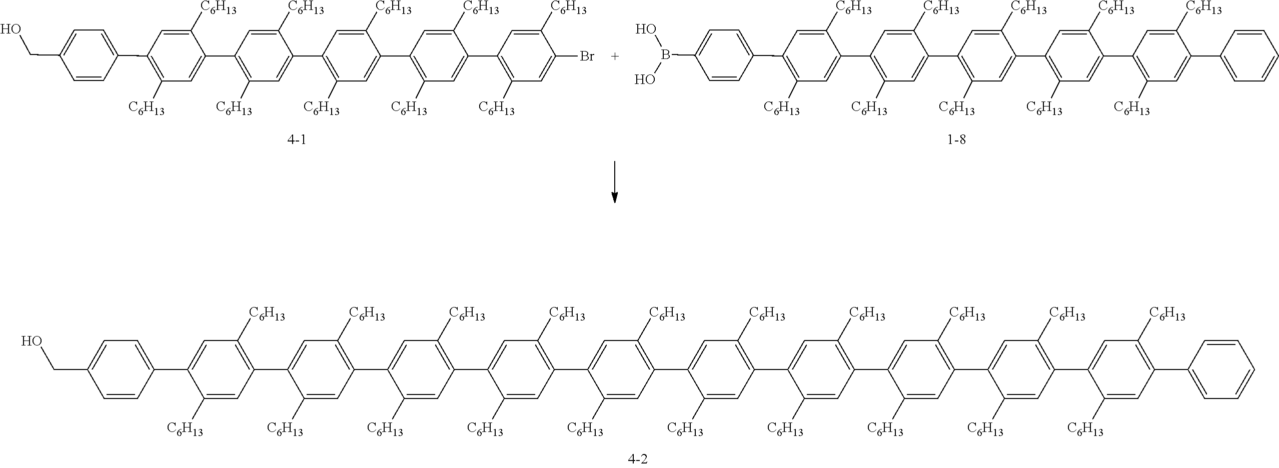

A solution of sodium carbonate (33.8 mg, 0.32 mmol) in water (0.1 mL) was added to a solution of Intermediate 4-1 (225 mg, 0.16 mmol) and Intermediate 1-8 (214 mg, 0.16 mmol) in a mixture of THF (5 mL) and ethanol (1 mL). The reaction mixture was purged with N₂ for 15 minutes, tetrakis(triphenylphosphine) palladium (0) (18.4 mg, 0.016 mmol, 10 mol %) was added and the mixture refluxed at 90° C. for 24 hours. The cooled reaction mixture was diluted with water stirred for 10 minutes, and the resulting solid filtered and triturated in a mixture of DCM and hexane (1:1) followed by trituration with acetonitrile to afford Intermediate 4-2 (0.2 g, 48% yield). LCMS: 80.0% purity.

### Synthesis of Oligomer A1

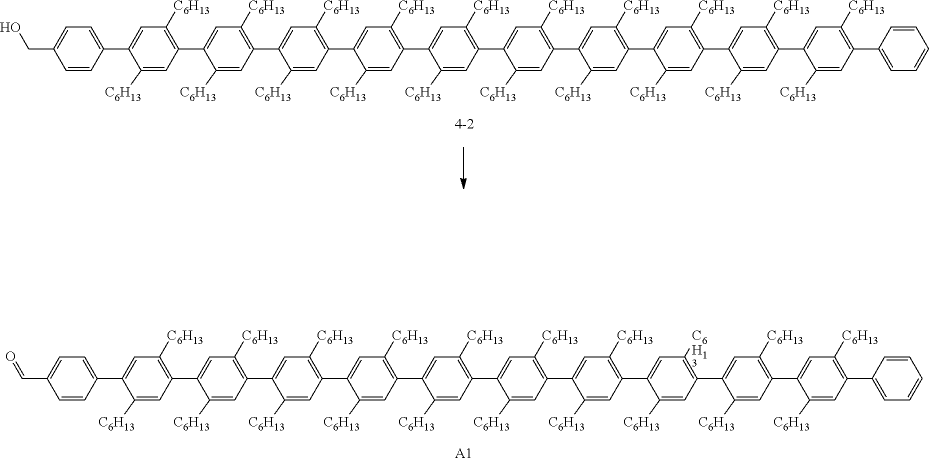

Manganese dioxide (165 mg, 1.90 mmol) was added to a solution of Intermediate 4-2 (0.5 g, 0.19 mmol) in chloroform (30 mL). After heating the reaction mixture at 65° C. for 16 hours. it was filtered hot and the filtrate concentrated under reduced pressure. The crude product was recrystallized from acetonitrile to afford Oligomer A1 as a while solid (330 mg, 66% yield).

¹H-NMR (400 MHz, CDCl₃): δ [ppm] 0.85-0.86 (m, 60H), 1.03-1.12 (m, 120H), 7.02-7.21 (m, 20H), 7.38-7.40 (m, 1H), 7.42-7.54 (m, 4H), 7.61 (d, J=8.00 Hz, 2H), 7.99 (d, J=8.40 Hz, 2H), 10.12 (s, 1H). LCMS: 93.1% purity.

### Synthesis of Polymer Examples

| Polymer Coil | Structure | Mw |
|---|---|---|
| B1 | 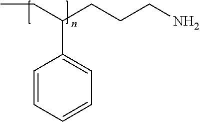 | 20500 |
| B2 | 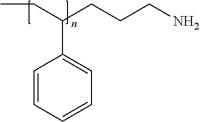 | 355000 |
| B3 | 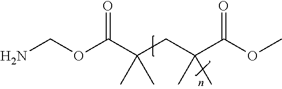 | 23220 |

Polymer Examples 1 and 2 were prepared from Rod Oligomer A1 and Polymer Coil B1 and B2, respectively, according to the following reaction scheme:

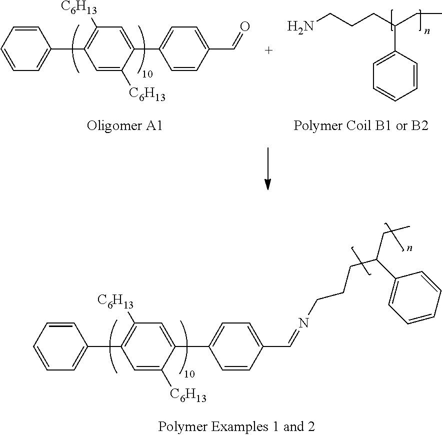

### Polymer Example 1

A 2 mL glass vial with a septum screw cap or ACE pressure tube (4 mL), charged with Oligomer A1 (20 mg, 1.0 eqv.), Polymer Coil B1 (156 mg, 1.0 eqv.), m-cresol (5 μL) and toluene (1 mL), was closed under N₂ and the reaction mixture stirred at 90-95° C. for 24 hours. After cooling to room temperature, the reaction mixture was poured into n-heptane, the precipitate was filtered, washed with methanol and dried under vacuum to afford Polymer Example 1 as a powdery colourless solid (91% yield).

The melting point of the material is 140-152° C., and the materials show T_{g} around 110° C.

There are no observable crystallization events in DSC experiments.

### Polymer Example 2

A 2 mL glass vial with a septum screw cap or ACE pressure tube (4 mL), charged with Oligomer A1 (2 mg, 1.0 eqv.), Polymer Coil B2 (228 mg, 1.0 eqv.), m-cresol (5 μL) and toluene (1 mL), was closed under N₂ and the reaction mixture stirred at 90-95° C. for 24 hours. After cooling to room temperature the reaction mixture was poured into n-heptane the precipitate was filtered off, washed with methanol and dried under vacuum to afford Polymer Example 2 as a powdery colourless solid (73% yield).

### Polymer Example 3

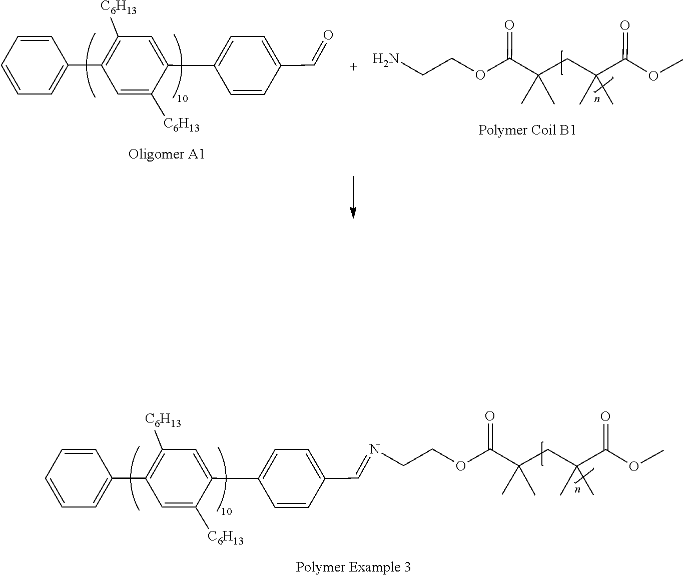

A 2 mL glass vial with a septum screw cap or ACE pressure tube (4 mL), charged with Oligomer A1 (20 mg, 1.0 eqv.), Polymer Coil B3 (175 mg, 1.0 eqv.), m-cresol (5 μL), and toluene (1 mL), was closed under N₂ and the reaction mixture stirred at 90-95° C. for 48 hours. After cooling to room temperature, the reaction mixture was poured into n-heptane, the precipitate filtered off, washed with methanol and dried under vacuum to afford Polymer Example 3 as a powdery colourless solid (91% yield).

The melting point of the material is 140-152° C., and the materials show T_{g} around 110° C. There are no observable crystallization events in DSC experiments.

### Self-Assembly

A solution of the rod-coil polymer (<2 wt. % in toluene) was cast onto a silicon wafer by spin-coating to make a film with thickness, less than 100 nm. The film was thermally annealed under vacuum conditions at well above the glass transition point of the block copolymer (>180° C.) for at least 2 hours. Polymer properties and annealing conditions are set out in Table 1.

TABLE 1

| | | | | | | Polymer Self-Assembly | | |
|---|---|---|---|---|---|---|---|---|
| | | | | | | Sample | | |
| Polymer Analysis | | | | | | concentration | Annealing | |
| Polymer | GPC Data | | | Melting | Tg | wt % in | Temp. | Time |
| Examples | Mn | Mw | PDI | point | ° C. | Toluene | ° C. | hr |
| 1 | 15858 | 23739 | 1.5 | 140-152 | ~110 | 0.5-1 | 180-200 | 2-15 |
| 2 | — | — | — | 180-230 | 110-120 | 0.25-0.5 | 200 | 2-10 |
| 3 | 21070 | 24629 | 1.17 | 168-190 | 120-130 | 0.5-2 | 190 | 5-6 |

After cooling the phase separated structure was observed by AFM imaging.

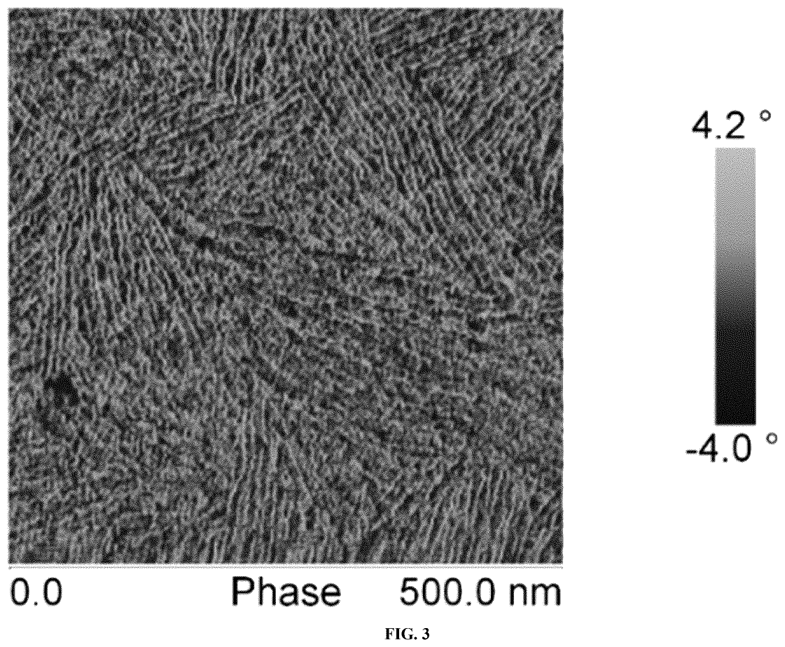

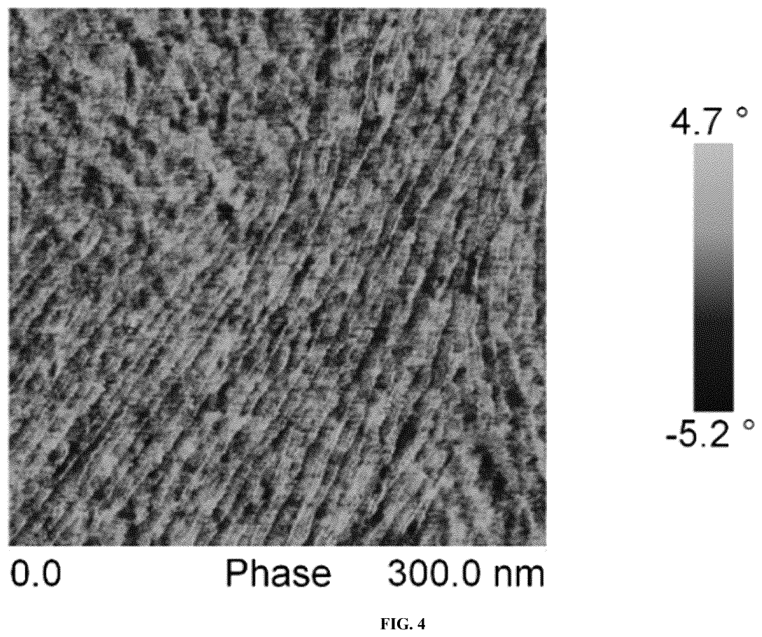

With reference to FIGS. 3 and 4, AFM images confirmed the presence of lamellar structures in the film with a characteristic dimension of 6-10 nm.

1.-16. (canceled)

17. A method of patterning a substrate comprising providing a directed self-assembled rod-coil block copolymer comprising a rod block A and a coil block B over a surface of the substrate; selectively removing one of the rod block A and the coil block B; and patterning the substrate.

18. The method according to claim 17 wherein the substrate is a silicon substrate.

19. The method according to claim 17 wherein providing the directed self-assembled rod-coil block copolymer over the surface comprises deposition of a solution comprising the rod-coil block copolymer and a solvent on the surface and evaporating the solvent.

20. The method according to claim 17 wherein the rod block A has a conjugated backbone.

21. The method according to claim 17 wherein the rod block A comprises units selected from vinylene, acetylene, imine, Ar¹ and combinations thereof, each of which may be unsubstituted or substituted with one or more substituents, wherein Ar¹ is an arylene or heteroarylene group.

22. The method according to claim 21 wherein the rod block A has formula (I): 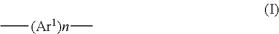
wherein Ar¹ is a monocyclic or fused aromatic or heteroaromatic group and n is greater than 1.

23. The method according to claim 21 wherein Ar¹ is unsubstituted or substituted phenylene.

24. The method according to claim 17 wherein the coil block has a backbone containing no double bonds or triple bonds conjugated to one another.

25. The method according to claim 24 wherein the coil block backbone contains no double bonds or triple bonds.

26. The method according to claim 17 wherein the coil block B is selected from formulae (II)-(VII): 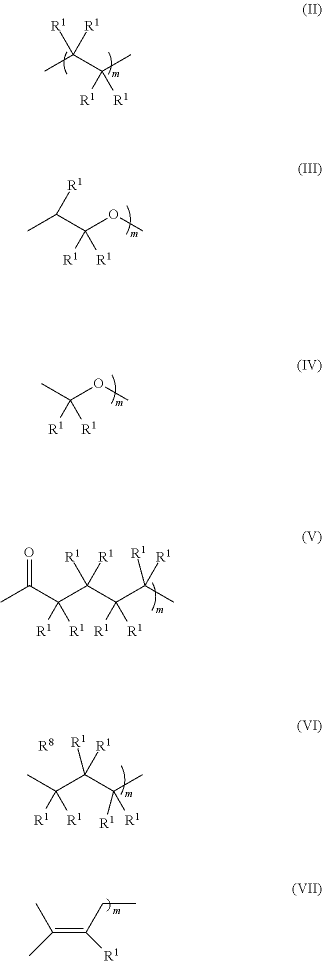
wherein R¹ in each occurrence is independently H or a substituent and m is greater than 1.

27. The method according to claim 17 wherein the rod-coil block copolymer comprises a linking unit linking rod block A to coil block B.

28. The method according to claim 27 wherein the linking unit is an imine unit of formula —N═CR⁹— wherein R⁹ is H or a substituent.

29. The method according to claim 27 wherein the linking unit is an optionally substituted monocyclic or polycyclic group.

30. The method according to claim 17 wherein the rod-coil block copolymer is selected from: an A-B rod-coil block copolymer; an A-B-A rod-coil block copolymer; and a B-A-B rod-coil block copolymer.

31. The method according to claim 17 wherein the rod-coil block copolymer comprises a fused aromatic or heteroaromatic end group comprising at least 4 fused aromatic or heteroaromatic rings.

32. The method according to claim 17 wherein the surface comprises at least one feature for directing self-assembly of the rod-coil block copolymer.

33. The method according to claim 32 wherein the at least one feature for directing self-assembly defines one or more areas of the substrate having a different surface energy from the remaining areas of the substrate.

34. The method according to claim 33 wherein the deposited rod-coil block copolymer is heated to above a glass transition temperature of the rod-coil block copolymer.
